(19) United States
(12) Patent Application Publication
(10) Pub. No.: US 2002/0126830 A1
(43) Pub. Date: Sep. 12, 2002

(54) Phone apparatus having a ringing device

(76) Inventor: Laurent Lucat, Le Mans (FR)

Correspondence Address: Corporate Patent Counsel, U.S. Philips Corporation, 580 White Plains Road, Tarrytown, NY, 10591, US

(21) Appl. No.: 10/029,808

(22) Filed: Dec. 27, 2001

(30) Foreign Application Priority Data
Dec. 28, 2000 (EP) 00403698.4

(51) Int. Cl. H04M 1/00; H04M 3/00

(52) U.S. Cl. 379/373.01; 379/374.02

(57) ABSTRACT

Apparatus, in which the ringing device is driven by the human voice and includes an input audio analysis module which converts the audio data provided by the user into a sequence of notes to be played.

At least another way for providing ringing melody is installed.

The invention is related to a phone apparatus having a ringing device.

At the present time, there are several methods to play a melody as a ringing on a wired or wireless telephone:

The parameters of the melody, e.g. pitch and duration (but this can also include other parameters such as the volume) are specified at the design of the phone, i.e. at the development stage. This allows to produce interesting melodies which are specified once by a sound designer. The main disadvantage is that these melodies are not chosen by the user (the customer) itself, including the consequence that all customers does have the same ones.

The invention proposes to the user the possibility to design his own ringing melody.

Such an apparatus is characterized in that said ringing device is driven by the human voice.

These and other aspects of the invention are apparent from and will be elucidated, by way of non-limitative example, with reference to the embodiment(s) described hereinafter.

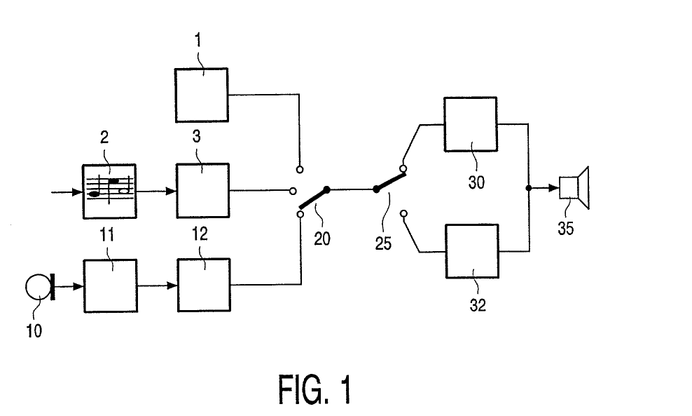

FIG. 1 shows an apparatus in accordance with the invention.

In some cases, the parameters of the melody are selected by the user, in the best case using a slave which is plotted on the telephone display screen: a note appears on the slave and can be moved on it, using the keyboard, to reach a given vertical position on the slave (corresponding to a given pitch). This offers a musical score-like interface between the user and the ringing generator. However, the major limitation is that this kind of interface can in fact be efficiently used only by musician users (who know what note to enter for playing a given melody); non-musician users can only enter melodies that they can read on external scores, that is, they can not enter any melody they want to play.

This proposal aims to alleviate the above-mentioned problem, i.e. the non-usability of a displayed score-like interface for non-musician customers, to specify desired melodies for the (wired or wireless) telephone ringing.

In accordance with an aspect of the invention, the generation of a ringing melody on a telephone can be designed by a plurality of ways:

Box 1 at the FIG. 1 shows the predefined melody data embedded in the phone. Boxes 2 and 3 are applicable for musician men. The melody is written in 2 and the written melodies are made available in the box 3.

The third design corresponds to a preferred embodiment of the invention.

The principle is to use an acoustical interface formed by a microphone 10 and a signal processing module 11 to generate the note sequence (with associated rhythms, . . . ) to be played. Using this system, the user has simply to sing (or whistle) the melody he wants to be ringed; this is done using the telephone microphone 10. Hence, no musical knowledge is required. The signal is then analyzed by the signal processing module 11, in order to transform it into a sequence of musical notes. The main information that has to be extracted is the pitch value and the duration. In the box 12, some user melodies are stored.

The user can choose by acting on a switch 20 the ringing way, ringing melody from 1, from 2-3 or from 10-11-12. By acting another switch 25, a sinusoidal-like generator 30 or an Instrumental synthesis 32 can operate. The loudspeaker the input of which is connected to the outputs of 30 and 35 provides the ringing melody for the users.

Several methods may be used to extract the pitch information, such as a temporal or frequency analysis. The analysis has to be done on frames (e.g. of 10 or 20 ms); the sequence of pitch values (one per frame) may be smoothed due to the local stationarity of the melody, thus increasing the analysis reliability. A large fluctuation in the smoothed pitch sequence indicates a change of note, thus providing a melody segmentation and the duration values.

Note that this solution does not require specific hardware components, since the microphone is already integrated and the signal analysis can be done by the DSP. Furthermore, the computational complexity is not a critical point, since there is no need to perform the signal analysis in real time.

The proposed method may be integrated in all types of telephone, wired as well as wireless.

As explained before, it improves the ringing generation functionality in the way that all users, musician or not, can easily design the melody they want to be played, without cost increase.

Pitch extraction has been done here using the AMDF method (Average Mean Difference Function). This method is known for providing good results relative to a low complexity. This function is defined by:

$$A M D F ( τ ) = \frac{{\sum }_{i = 1}^{N} \vert {S}_{i + τ} - {S}_{i} \vert}{{\sum }_{i = 1}^{N} \vert {S}_{i} \vert}$$

where {Sᵢ}_{i=1, . . . N} and τ denote the samples involved in the pitch search and a given (candidate) pitch period, respectively. This function has holes located at the signal pitch period and often sub- and upper-multiples of it (often with a lower amplitude).

Then, a post-processing is done in order to segment the pitch (one per frame) sequence into a note sequence. First, the job is to remove octave-type error (i.e. detection of the half real pitch F_{c}/2). This is done by comparing the AMDF scores at τ=F_{c}/2 and τ=F_{c}

The second step is devoted to remove isolated pitch values located in the transitions between consecutive notes, or occurring inside a note due to the human voice fluctuations this is done using iterative median filtering.

The third step aims to finalize the melody segmentation: whenever the pitch value is constant over a minimal required number of consecutive frames, it is assumed that this correspond to a note; elsewhere, thus not corresponding to a note, the pitches are affected to the value of the nearest already detected note. Hence, a dense sequence of step-like pitch values is obtained. Each step corresponds to a note, thus providing the melody segmentation. Duration of each note is directly obtained from this segmentation.

Other methods can be used for pitch extraction and post-processing, ranging from simple techniques such as the ZCR (Zero Crossing Rate), to complex schemes including HMM (Hidden Markov Models). Post-processing has to be defined w.r.t. the detection process in order to make it more robust against noise, human voice characteristics and fluctuations.

1. Phone apparatus having a ringing device, characterized in that said ringing device is driven by the human voice.

2. Apparatus as claimed in claim 1, characterized in that said ringing device includes an input audio analysis module which converts the audio data provided by the user into a sequence of notes to be played.

3. Apparatus as claimed in claim 2, characterized in that the audio data provided by the user are obtained by singing (or whistling).

4. Apparatus as claimed in claims 1 or 3, characterized in that at least another way for providing ringing melody is installed.

5. Apparatus as claimed in claim 4 characterized in that another way for providing ringing melody consists to determine musical notes by displaying them on a display screen.

6. Apparatus as claimed in claims 1-5 characterized in that an instrumental synthesis is connected to the input of a loudspeaker.

7. Apparatus as claimed in claims 1-6 characterized in that a sinusoidal-like generator is connected to the input of a loudspeaker.

8. Apparatus as claimed in claims 6 and 7 characterized in that an instrumental synthesis or a sinusoidal-like generator can be connected to the input of the loudspeaker according to the choose of the user.
